(19) United States
(12) Patent Application Publication
(10) Pub. No.: US 2013/0280553 A1
(43) Pub. Date: Oct. 24, 2013

(54) WORKPIECE HAVING GLOSSY COATING LAYER

(71) Applicants: CHENG-YUNG LEE, NEW TAIPEI CITY (TW); SHUN-FA KANG, NEW TAIPEI CITY (TW)

(72) Inventors: CHENG-YUNG LEE, NEW TAIPEI CITY (TW); SHUN-FA KANG, NEW TAIPEI CITY (TW)

(73) Assignee: UNIVERSAL TRIM SUPPLY CO., LTD., NEW TAIPEI CITY (TW)

(21) Appl. No.: 13/466,409

(22) Filed: May 8, 2012

(30) Foreign Application Priority Data
Apr. 20, 2012 (TW) 101207444

(51) Int. Cl. C25D 17/16; B32B 3/14; B32B 15/01

(52) U.S. Cl. 428/656; 205/50; 205/143; 428/615

(57) ABSTRACT

A workpiece has a glossy coating layer disposed thereon. A barrel plating device is electrified with an alternating current, which has a voltage between 1V and 100V, a current density between 0.02 A/dm² and 50 A/dm², and a frequency between 1 Hz to 60 KHz. The alternating current is rectified by a low ripple DC rectifier into a direct current whose ripple coefficient is between 0.3% and 26%. Thereby, a surface of the workpiece is electroplated with the glossy coating layer, which contributes to a glossy and even effect on the surface of the workpiece.

### FIELD OF THE INVENTION

The present invention relates to a workpiece having a glossy coating layer, which is especially electroplated via a barrel plating device, thereby resulting in a specular surface that is bright and even presented on the workpiece.

### DESCRIPTION OF THE RELATED ART

Workpieces like buckles, zippers, screws, or nuts likely present a dark color, a shoddy reflecting effect, or an uneven surface in view of the material adopted. Such low-grade workpieces are usually not conspicuous enough for consumers.

### SUMMARY OF THE INVENTION

The object of the present invention is to provide a workpiece having a bright and even surface with a gloss by building a coating layer thereon. The workpiece having a glossy coating layer comprising:

a workpiece; and a glossy coating layer; a barrel plating device being electrified with an alternating current, which has a voltage between 1V and 100V, a current density between 0.02 A/dm² and 50 A/dm², and a frequency between 1 Hz to 60 KHz; the alternating current being rectified by a low ripple DC rectifier into a direct current whose ripple coefficient is between 0.3% and 26%; a surface of the workpiece being electroplated with the glossy coating layer.

Preferably, the workpiece adopts a metal material. Moreover, the surface of the workpiece includes an electroplating area and a non-electroplating area. The non-electroplating area is wrapped in an insulating layer. The electroplating area of the workpiece is electroplated with the glossy coating layer disposed on the electroplating area.

Preferably, the workpiece adopts a non-metal material; the workpiece includes a metal surface disposed thereon; the metal surface is electroplated with the glossy coating layer.

Preferably, the glossy coating layer adopts a trivalent chromium layer, a brass layer, or a bright tin layer.

Novelty and inventive steps of the present invention are as follows:

The workpiece is electroplated with a gloss presented on the coating layer by means of barrel plating, which conduces to a specular and even surface on the workpiece. Favorably, the surface of the workpiece is more attractive.

### BRIEF DESCRIPTION OF THE DRAWINGS

FIG. 1 is a cross-sectional view of a workpiece of the present invention;

FIG. 2 is a schematic view showing a barrel plating device of the present invention;

FIG. 3 is a cross-sectional view of a second preferred embodiment of the present invention; and

FIG. 4 is a cross-sectional view of a third preferred embodiment of the present invention.

### DETAILED DESCRIPTION OF THE PREFERRED EMBODIMENTS

The present invention could be clearly explained by the following embodiments.

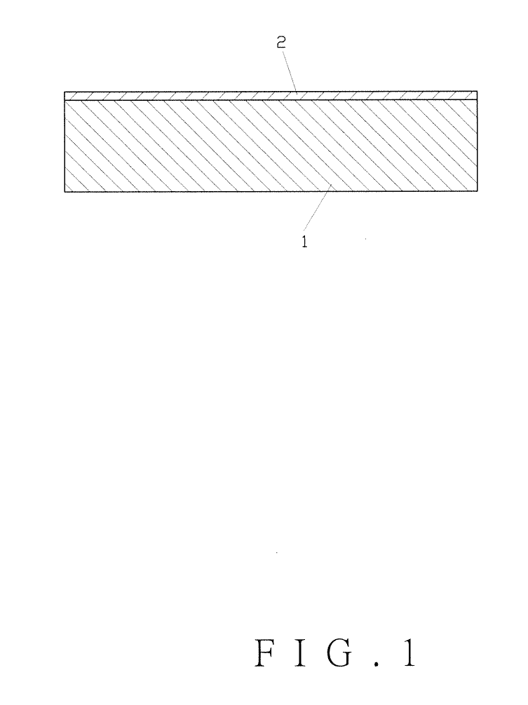

FIG. 1 shows a first preferred embodiment of the present invention comprising:

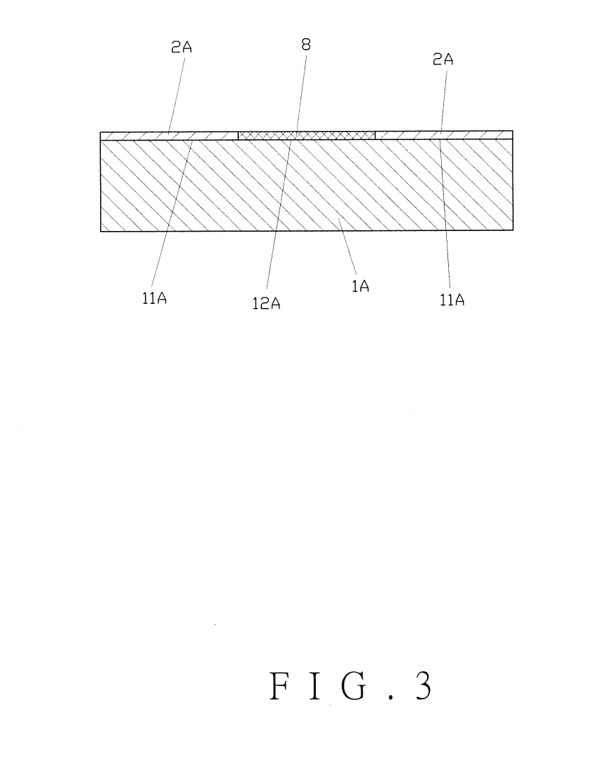

a metal workpiece (1) which could be a screw, a nut, a metal zipper, a metal buckle, or an alike part; and a glossy coating layer (2); a barrel plating device (3) being electrified with an alternating current, which has a voltage between 1V and 100V, a current density between 0.02 A/dm² and 50 A/dm², and a frequency between 1 Hz to 60 KHz; the alternating current being rectified by a low ripple DC rectifier into a direct current whose ripple coefficient is between 0.3% and 26%; a surface of the workpiece (1) being electroplated with the glossy coating layer (2); the glossy coating layer (2) adopts a trivalent chromium layer, a brass layer, or a bright tin layer, and the barrel plating device (3) is shown in FIG. 3.

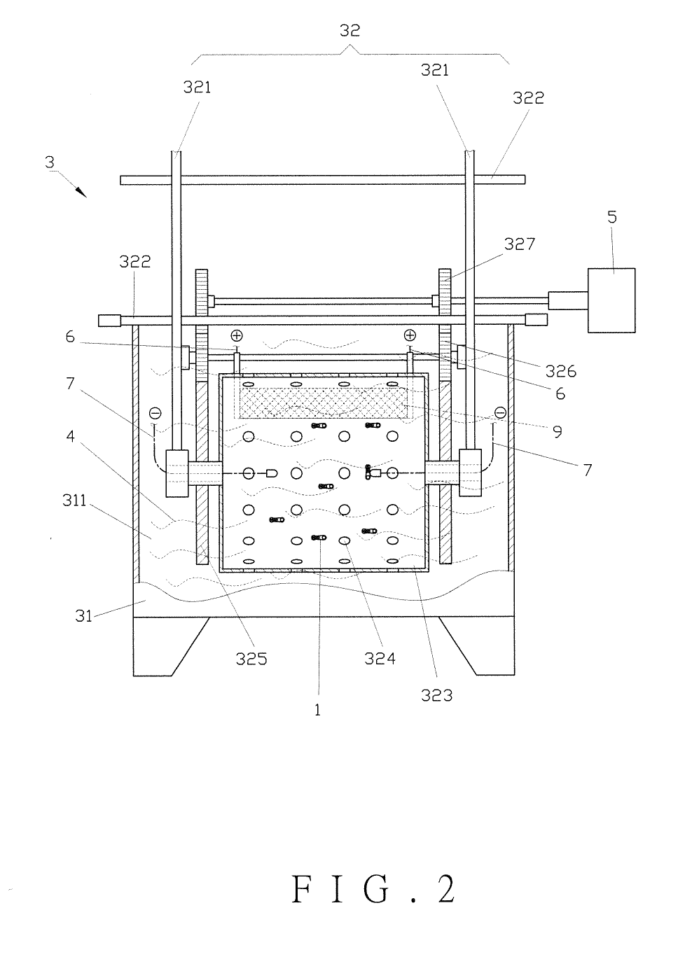

Referring to FIG. 2, the barrel plating device (3) includes:

a base (31), in which an electroplating trough (311) is formed and added with a plating solution (4) of trivalent chromium ion, brass ion, or tin ion for electroplating; a barrel unit (32) having a pair of correspondent frames (321), at least one shaft (322) disposed between the frames (321), and a barrel body (323) disposed between the frames (321); the barrel body (323) defining a plurality of apertures (324) thereon; two sides of the barrel body (323) being provided with a first gear (325), respectively; the first gear (325) meshing with a second gear (326), and the second gear (326) meshing with a third gear (327); a motor (5) being engaged with the third gear (327). Moreover, the frames (321) of the barrel unit (32) are suspended by a suspension, which is disclosed before, so it is not shown in the figure.

Place a plurality of workpieces (1) into the barrel body (323). Place a positive electrical conductor (6) that connects to an anode basket (9) into the electroplating trough (311). Protrude a negative electrical conductor (7) into the barrel body (323) via the two sides of the same. Place the barrel body (323) into the electroplating trough (311) of the base (31), whereby the plating solution (4) enters the barrel body (323) via the apertures (324) defined thereon. Turning on the motor (5) triggers a rotation of the third gear (327), so that the third gear (327) rotates the second gear (326), and the second gear (326) further rotates the first gear (325). Whereby, the barrel body (323) rolls in the electroplating trough (311). When the positive electrical conductor (6) and the negative electrical conductor (7) are electrified in accordance with afore coefficient, the rolling barrel body (323) allows the workpieces (1) to circularly attach to the negative electrical conductor (7). The plating solution (4) allows a positive metal ion, such as the trivalent chromium ion, brass ion, or tin ion, to be reduced to a metal bright coating layer (2) that is arranged densely on the workpieces (1) in view of redox. Accordingly, the surfaces of the workpieces (1) are specularly bright and even.

A second preferred embodiment of the present invention is shown in FIG. 3 as follows:

A workpiece (1A) adopts a metal material. A surface of the workpiece (1A) includes an electroplating area (11A) and a non-electroplating area (12A). The non-electroplating area (12A) is wrapped in an insulating layer (8). The workpiece (1A) is electroplated via the barrel plating device (3), and a glossy coating layer (2A) is disposed on the electroplating area (11A) of the workpiece (1A). The insulating layer (8) adopts a material that can be removed from the non-electroplating area (12A) after the electroplating of the glossy coating layer (2A) is complete on the electroplating area (11A).

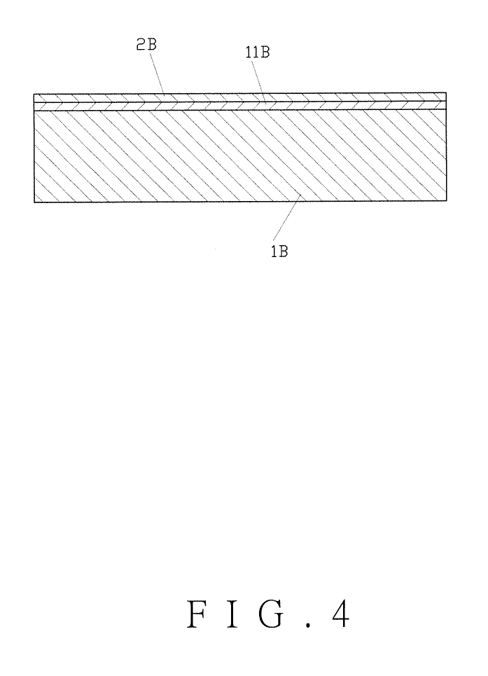

A third preferred embodiment is shown in FIG. 4 as follows:

A workpiece (1B) adopts a non-metal material. The workpiece (1B) includes a metal surface (11B) disposed thereon. The metal surface (11B) is electroplated with the glossy coating layer (2B) by same means disclosed in the first preferred embodiment.

While we have shown and described the embodiment in accordance with the present invention, it should be clear to those skilled in the art that further embodiments may be made without departing from the scope of the present invention.

I claim:

1. A workpiece having a glossy coating layer comprising:
a workpiece; and
a glossy coating layer; a barrel plating device being electrified with an alternating current, which has a voltage between 1V and 100V, a current density between 0.02 A/dm² and 50 A/dm², and a frequency between 1 Hz to 60 KHz; said alternating current being rectified by a low ripple DC rectifier into a direct current whose ripple coefficient is between 0.3% and 26%; a surface of said workpiece being electroplated with said glossy coating layer.

2. The workpiece as claimed in claim 1, wherein, said workpiece adopts a metal material.

3. The workpiece as claimed in claim 2, wherein, said surface of said workpiece includes an electroplating area and a non-electroplating area; said non-electroplating area is wrapped in an insulating layer; said electroplating area of said workpiece is electroplated with said glossy coating layer.

4. The workpiece as claimed in claim 1, wherein, the workpiece adopts a non-metal material; said workpiece includes a metal surface disposed thereon; said metal surface is electroplated with said glossy coating layer.

5. The workpiece as claimed in claim 1, wherein, said glossy coating layer adopts a trivalent chromium layer, a brass layer, or a bright tin layer.

6. A method for electroplating a workpiece with a glossy coating layer comprising steps of:
A. preparing a barrel plating device; said barrel plating device including:
a base, in which an electroplating trough is formed; a barrel unit having a pair of correspondent frames, at least one shaft disposed between said frames, and a barrel body disposed between said frames; said barrel body defining a plurality of apertures thereon; two sides of said barrel body being provided with a first gear, respectively; said first gear meshing with a second gear, and said second gear meshing with a third gear; a motor being engaged with said third gear;
B. placing a plating solution into said electroplating trough;
C. placing a plurality of workpieces into said barrel body; placing a positive electrical conductor that connects to an anode basket into said electroplating trough and soaking said positive electrical conductor in said plating solution; protruding a negative electrical conductor into said barrel body via said two sides thereof; placing said barrel body into said electroplating trough of said base, whereby said plating solution enters said barrel body via said apertures thereof; turning on said motor triggering a rotation of said third gear so that said third gear rotating said second gear, and said second gear further rotating said first gear; whereby, said barrel body rolling in said electroplating trough; and
D. said positive electrical conductor and said negative electrical conductor being electrified by an alternating current, which has a voltage between 1V and 100V, a current density between 0.02 A/dm² and 50 A/dm², and a frequency between 1 Hz to 60 KHz; said alternating current being rectified by a low ripple DC rectifier into a direct current whose ripple coefficient is between 0.3% and 26%; said rolling barrel body allowing said workpieces to circularly attach to said negative electrical conductor; said plating solution allowing a positive metal ion to be reduced to a metal bright coating layer that is arranged densely on said workpieces in view of redox.
